(19) United States
(12) Patent Application Publication
(10) Pub. No.: US 2014/0215075 A1
(43) Pub. Date: Jul. 31, 2014

(54) LOAD BALANCING APPARATUS AND METHOD BASED ON ESTIMATION OF RESOURCE USAGE

(71) Applicant: Electronics and Telecommunications Research Institute, Daejeon-si (KR)

(72) Inventors: Nam-Kyung LEE, Daejeon-si (KR); Chang-Woo YOON, Daejeon-si (KR)

(73) Assignee: Electronics and Telecommunications Research Institute, Daejeon-si (KR)

(21) Appl. No.: 14/014,951

(22) Filed: Aug. 30, 2013

(30) Foreign Application Priority Data
Jan. 30, 2013 (KR) 10-2013-0010564

(51) Int. Cl. H04L 12/911

(52) U.S. Cl. CPC H04L 47/70
USPC 709/226

(57) ABSTRACT

Provided are a load balancing apparatus and method based on estimation of resource usage. The load balancing apparatus includes a service platform configured to generate service resource information including information on respective necessary resource amounts for providing a plurality of pieces of content, a service processor configured to have one or at least two service units, and generate service unit information including information on amounts of resources allocated to the respective one or at least two service units, and a load balancer configured to compare the received service resource information with the received service unit information on the basis of a received service identification (ID) number and select a service unit for providing a service corresponding to the received service ID number from among the one or at least two service units.

### CROSS-REFERENCE TO RELATED APPLICATION

This application claims the benefit under 35 U.S.C. §119(a) of Korean Patent Application No. 10-2013-0010564, filed on Jan. 30, 2013, the entire disclosure of which is incorporated herein by reference for all purposes.

### BACKGROUND

1. Field

The following description relates to technology on a load balancing method for providing a broadcasting service to a user in a cloud computing-based broadcasting service system, and more particularly, to a load balancing apparatus and method based on estimation of resource usage.

2. Description of the Related Art

Internet protocol television (IPTV) that is an Internet-based broadcasting service provides an information service, moving picture content, a broadcasting service, etc. through a TV set using the Internet at a very high speed. Due to the development of network technology and cloud-computing technology, a content service in which an IPTV is combined with a cloud-computing service is being developed. Service provided by a service platform of a cloud computing-based IPTV system has a real-time characteristic that fundamental services represented by a broadcasting service and a communication service are fused together. A communication service represented by an application service is provided to subscribers on the basis of a cloud-computing system by service providers belonging to an IPTV system. However, in a cloud-computing system that provides service to a plurality of users through a virtual service unit in this way, access is concentrated on some service units according to preference of users, and it becomes difficult to smoothly provide the service.

Korean Patent Publication No. 2002-0030952 discloses a method for efficiently balancing a load among multiple servers when a cluster is formed of servers providing the same service. The method involves load balancing over a network based on the number of connections to each clustering server. However, a plurality of users who use a service demand different service resources, and it is difficult to efficiently distribute resources available for the service.

### SUMMARY

The following description relates to managing the amount of resources necessary for each service provided by an application server group belonging to a service platform as a profile, monitoring states of service units belonging to a service unit pool, and thereby assigning an optimal service unit in response to a user's request for a new service to provide smooth service through efficient service resource allocation.

In one general aspect, a load balancing apparatus based on estimation of resource usage includes: a service platform configured to store a plurality of pieces of content, and generate service resource information including information on respective necessary resource amounts for providing the plurality of pieces of content; a service processor configured to have one or at least two service units, and generate service unit information including information on amounts of resources allocated to the respective one or at least two service units; and a load balancer configured to compare the received service resource information with the received service unit information on the basis of a received service identification (ID) number, and select a service unit for providing a service corresponding to the received service ID number from among the one or at least two service units.

The load balancer may search the received service resource information for information on a necessary resource amount of content corresponding to the received service ID number, compare the necessary resource amount of the content corresponding to the received service ID number with the amounts of resources allocated to the service units included in the received service unit information, select a service unit capable of providing the content corresponding to the received service ID number among the one or at least two service units, and provide the service. The service resource information may include information on computing resources necessary to provide the respective pieces of content to a user. Also, resources allocated to the service unit for providing the service corresponding to the received service ID number may be the necessary resource amount of the content corresponding to the received service ID number or more.

In another general aspect, a load balancing method based on estimation of resource usage includes: receiving a service ID number; checking a necessary resource amount of content corresponding to the received service ID number; searching for one or at least two service units on the basis of the checked necessary resource amount; and selecting a service unit for providing the content corresponding to the received service ID number according to a search result, and providing a service. The load balancing method may further include determining whether or not the received service ID number is intended for a service request. The searching of the one or at least two service units on the basis of the checked necessary resource amount may include: comparing computing resources allocated to each of the one or at least two service units with the checked necessary resource amount; and searching for and selecting the service unit having computing resources of the checked necessary resource amount or more as a result of the comparison.

Other features and aspects will be apparent from the following detailed description, the drawings, and the claims.

### BRIEF DESCRIPTION OF THE DRAWINGS

FIG. 1 is a block diagram of a load balancing apparatus based on estimation of resource usage according to an embodiment of the present invention.

FIG. 2 is a flowchart illustrating a data flow of a load balancing apparatus based on estimation of resource usage according to an embodiment of the present invention.

FIG. 3 is a flowchart illustrating a load balancing method based on estimation of resource usage according to an embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

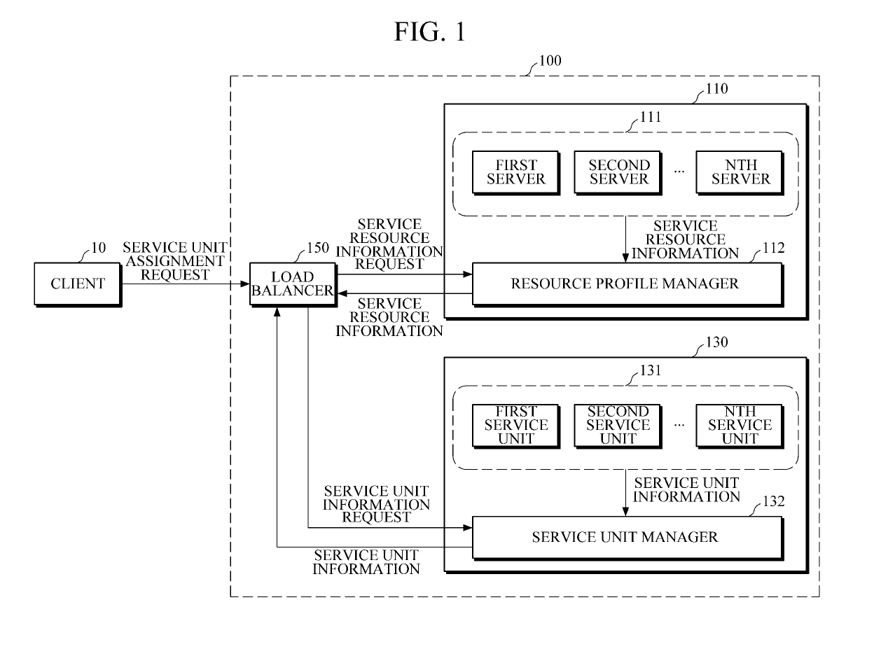

FIG. 1 is a block diagram of a load balancing apparatus 100 based on estimation of resource usage according to an embodiment of the present invention.

Referring to FIG. 1, the load balancing apparatus 100 based on estimation of resource usage according to an embodiment of the present invention includes a service platform 110, a service processor 130, and a load balancer 150.

The service platform 110 includes a content server 111 and a resource profile manager 112.

The content server 111 includes one or at least two servers, and each of the servers stores a plurality of pieces of content. The content server 111 provides service resource information to the resource profile manager 112. The service resource information includes service identification (ID) numbers for identifying the respective pieces of content stored in the one or at least two servers, and information on necessary resource amounts for executing the respective pieces of content. The content stored in the content server 111 includes moving picture content, music content, and an application to be provided to users. The content stored in the content server 111 is not limited to that mentioned above, and includes all kinds of content that a service provider can provide to users or subscribers.

On the basis of the service resource information received from the content server 111, the resource profile manager 112 generates and manages a resource profile including types of content prepared in the content server 111, the service ID numbers, and the information on necessary resource amounts for executing the respective pieces of content. The plurality of pieces of content stored in the content server 111 include image content, music content, and an application. Provision of such a content service demands calculation processing resources of a central processing unit (CPU), graphical processing resources of a graphics processing unit (GPU), predetermined memory resources, and so on. The amount of these computer resources necessary to provide the corresponding service is referred to as a necessary resource amount. A necessary resource amount of each content service may vary according to a type and quality of the service, a provision method, and so on.

In addition, the resource profile manager 112 receives a service resource information request from the load balancer 150. The service resource information request received from the load balancer 150 includes a request for necessary resource amount information on content corresponding to a service ID number received from a client 10. When the service resource information request is received from the load balancer 150, the resource profile manager 112 delivers service resource information including necessary resource amount information for executing the content to the load balancer 150 on the basis of service resource information received from the content server 111.

The load balancer 150 receives a service unit assignment request including the service ID number from the client 10. When a service request is received from a user, the client 10 delivers the service unit assignment request including the service ID number of a service corresponding to the user's service request to the load balancer 150. Service ID numbers indicate IDs allowing identification of the plurality of pieces of content stored in the content server 111 of the service platform 110.

The load balancer 150 delivers the request for service resource information on the service content corresponding to the received service ID number to the resource profile manager 112 of the service platform 110. The resource profile manager 112 receiving the service resource information request generates the service resource information including the necessary resource amount for providing the corresponding content, and delivers the generated service resource information to the load balancer 150.

From the service resource information received from the resource profile manager 112, the load balancer 150 finds the necessary resource amount for the content corresponding to the service ID. Also, the load balancer 150 requests service unit information including information on one or at least two service units 131 already assigned to the service processor 130 from a service unit manager 132 of the service processor 130. The service unit information includes states of resources allocated to each of the one or at least two service units 131 assigned to the service processor 130 and current execution information on the service units 131.

The load balancer 150 receives the service unit information including resource allocation information on the one or at least two service units 131 assigned to the service processor 130. The load balancer 150 selects a service unit capable of providing the content corresponding to the service ID number from among the one or at least two service units 131 of the service processor 130 in consideration of the resource allocation information on the one or at least two service units 131 and the execution information on the respective service units 131 included in the received service unit information.

In other words, the load balancer 150 selects a service unit 131 that is capable of processing the necessary resource amount for the content and has a small load during a process of providing the content to the client 10 from among the one or at least two service units 131. It is necessary for resources allocated to the service unit 131 selected by the load balancer 150 to be the necessary resource amount of the content corresponding to the service ID number or more. The load balancer 150 delivers information on the selected service unit 131 to the service unit manager 132.

The service processor 130 includes the service unit manager 132 and the one or at least two service units 131.

The one or at least two service units 131 execute the content stored in the content server 111, and provide execution results to the client. The service units 131 are allocated computer resources such as calculation processing resources, graphical processing resources, memory resources, or a storage capacity. Computer resources allocated to respective two or more service units 131 may differ from each other. The service units 131 may be formed, for example, in the form of virtual terminals.

The service unit manager 132 manages resources allocated to each of the one or at least two service units 131 assigned to the service processor 130, and generates service unit information including information on resources allocated to the respective service units 131. When a service unit information request is received from the load balancer 150, the service unit manager 132 delivers the generated service unit information to the load balancer 150. When the load balancer 150 selects the service unit 131 for providing the content corresponding to the service ID number, the service unit manager 132 receives information on the selected service unit 131 from the load balancer 150, and updates the information with the received information is on the selected service unit 131.

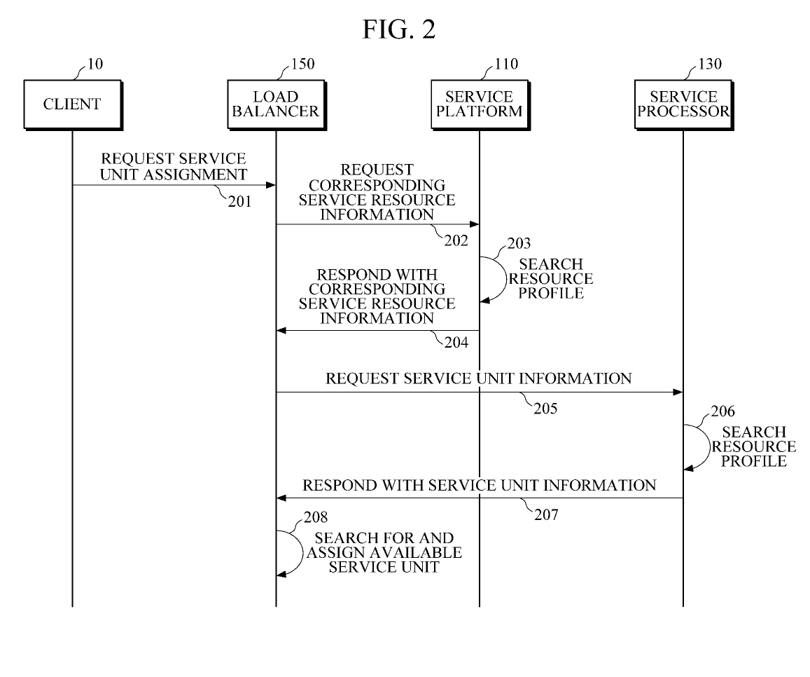

FIG. 2 is a flowchart illustrating a data flow of a load balancing apparatus 100 based on estimation of resource usage according to an embodiment of the present invention.

Referring to FIG. 2, in a data flow of the load balancing apparatus 100 based on estimation of resource usage according to an embodiment of the present invention, a load balancer 150 first receives a service unit assignment request from a client 10 (201). The client 10 delivers the service unit assignment request including a service ID number to provide a service to a user. Service ID numbers indicate IDs allowing identification of a plurality of pieces of content stored in a content server 111 of a service platform 110.

Next, the load balancer 150 requests resource information on the corresponding service from the service platform 110 according to the received service unit assignment request (202). The load balancer 150 requests service information on content corresponding to the service ID number included in the received service unit assignment request from the service platform 110.

The service platform 110 searches a resource profile on the basis of the received request for resource information on the corresponding service (203). When the request for a necessary resource amount of the service corresponding to the service ID number is received from the load balancer 150, the service platform 110 searches the stored plurality of pieces of content for the corresponding service, and finds the necessary resource amount of the searched service. Then, the service platform 110 delivers service resource information including the necessary resource amount information on the corresponding service as resource profile search results to the load balancer 150 (204).

Next, the load balancer 150 requests service unit information including service unit resource allocation information from a service processor 130 (205). The service unit is information includes a state of resources allocated to each of one or at least two service units assigned to the service processor 130 and current execution information on the service units.

The service processor 130 monitors the currently assigned service units in response to the received service unit information request (206). When the service unit information request is received from the load balancer 150, the service processor 130 monitors the assigned one or at least two service units to find a resource allocation state of each of the assigned one or at least two service units. Then, the service processor 130 delivers information on the found resource allocation states of the respective service units to the load balancer 150 (207).

Next, the load balancer 150 searches the received resource allocation state information on the service units for available service units, selects an appropriate service unit, and assigns the service to the selected service unit (208). The load balancer 150 receives service unit information including the resource allocation information on the one or at least two service units assigned to the service processor 130 from the service processor 130. The load balancer 150 selects a service unit capable of providing the content corresponding to the service ID number from among the one or at least two service units of the service processor 130 in consideration of the resource allocation information on the one or at least two service units included in the received service unit information.

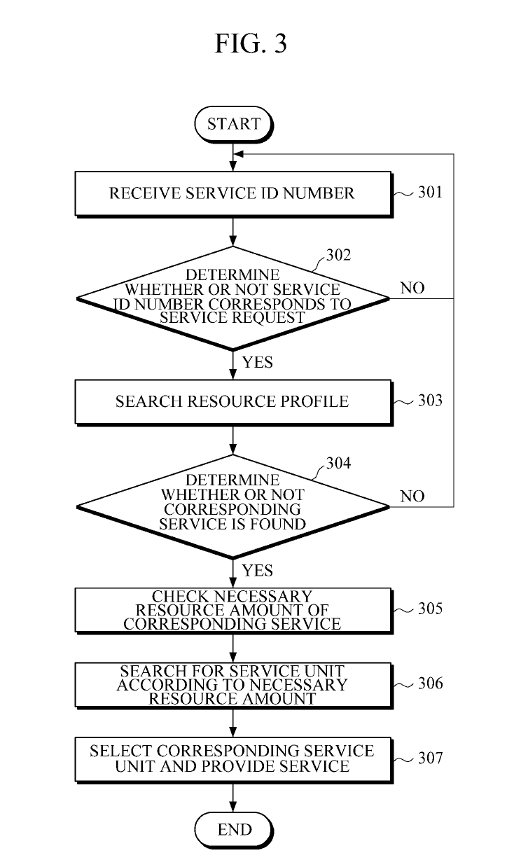

FIG. 3 is a flowchart illustrating a load balancing method based on estimation of resource usage according to an embodiment of the present invention.

Referring to FIG. 3, in a load balancing method based on estimation of resource usage according to an embodiment of the present invention, a service ID number is received first (301). When a user requests a content service including image content, music content, and an application, a client transmits the service ID number of the content service according to the user request. Then, it is determined whether or not the received service ID number is a service is request (302). When the service ID number is received from the client, it is determined whether or not the received service ID number requests a service.

When the received service ID number is a service request, a service corresponding to the received service ID number is searched for in a resource profile (303). The resource profile includes information on resources necessary to provide each of a plurality of pieces of stored content and each service. Thus, the service corresponding to the received service ID number is searched for in the resource profile, and it is determined whether or not the service corresponding to the received service ID number has been found in the resource profile (304).

When the service corresponding to the received service ID number is found in the resource profile, a necessary resource amount of the service corresponding to the received service ID number is checked (305). When the service corresponding to the received service ID number is found as a result of searching the resource profile, the amount of resources necessary to provide the service to the user is checked. When no service is found in the resource profile, there is no service corresponding to the received service ID number, and the process waits until a new service ID number is received.

Next, service units capable of providing the service are searched for on the basis of the necessary resource amount (306). When the necessary resource amount of the service corresponding to the received service ID number is checked in the resource profile, the amount of resources allocated to each of the one or at least two service units is found. The one or at least two service units assigned to a service processor provide a service including image content, music content, and an application according to a user request. Also, the one or at least two service units are assigned to have different amounts of resources. Among the one or at least two service units having different resource amounts, a service unit capable of processing the necessary resource amount found in the resource profile is searched for. When there is a is service unit capable of providing the service, the service unit is selected to provide the service (307).

A load balancing apparatus and method based on estimation of resource usage according to an embodiment of the present invention find service-specific necessary resource amounts using IDs given to respective services provided by a service platform including a plurality of service providers, assign service units according to the found necessary resource amounts, and thus can efficiently distribute a system's available resources.

The present invention can be implemented as computer readable codes in a computer readable record medium. The computer readable record medium includes all types of record media in which computer readable data is stored. Examples of the computer readable record medium include a ROM, a RAM, a CD-ROM, a magnetic tape, a floppy disk, and an optical data storage. Further, the record medium may be implemented in the form of a carrier wave such as Internet transmission. In addition, the computer readable record medium may be distributed to computer systems over a network, in which computer readable codes may be stored and executed in a distributed manner.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A load balancing apparatus based on estimation of resource usage, comprising:
a resource profile manager configured to receive and manage service resource information including information on a necessary resource amount for providing each of a plurality of pieces of stored content;
a service processor configured to have one or at least two service units, and generate service unit information including information on amounts of resources allocated to the respective one or at least two service units; and
a load balancer configured to compare the received service resource information with the received service unit information on the basis of a received service identification (ID) number, and select a service unit for providing content corresponding to the received service ID number from among the one or at least two service units.

2. The load balancing apparatus of claim 1, wherein the load balancer searches the received service resource information for information on a necessary resource amount of the content corresponding to the received service ID number, compares the necessary resource amount of the content corresponding to the received service ID number with the amounts of resources allocated to the service units included in the received service unit information, selects a service unit capable of providing the content corresponding to the received service ID number among the one or at least two service units, and provides the content.

3. The load balancing apparatus of claim 1, wherein the service resource information includes information on computing resources necessary to provide the respective pieces of content to a user.

4. The load balancing apparatus of claim 1, wherein the at least two service units have different computing resources.

5. The load balancing apparatus of claim 1, wherein the resources allocated to the service unit for providing the service corresponding to the received service ID number are the necessary resource amount of the content corresponding to the received service ID number or more.

6. A load balancing method based on estimation of resource usage, comprising:
receiving a service identification (ID) number;
checking a necessary resource amount of content corresponding to the received service ID number;
searching for one or at least two service units on the basis of the checked necessary resource amount; and
selecting a service unit for providing the content corresponding to the received service ID number according to a search result, and providing a service.

7. The load balancing method of claim 6, further comprising determining whether or not the received service ID number is intended for a service request.

8. The load balancing method of claim 6, wherein the searching of the one or at least two service units on the basis of the checked necessary resource amount includes:
comparing computing resources allocated to each of the one or at least two service units with the checked necessary resource amount; and
searching for and selecting the service unit having computing resources of the checked necessary resource amount or more as a result of the comparison.

9. The load balancing method of claim 6, wherein the necessary resource amount corresponds to computing resources necessary to provide the content to a user.

10. The load balancing method of claim 6, wherein the at least two service units have different computing resources.
